(19) United States
(12) Patent Application Publication
(10) Pub. No.: US 2011/0138002 A1
(43) Pub. Date: Jun. 9, 2011

(54) INTERACTIVITY TEST APPARATUS AND METHOD FOR BLOCKING IP APPLICATION SPAM

(75) Inventor: So Yung PARK, Daejeon (KR)

(73) Assignee: Electronic and Telecommunications Research Institute, Daejeon (KR)

(21) Appl. No.: 12/959,961

(22) Filed: Dec. 3, 2010

(30) Foreign Application Priority Data
Dec. 4, 2009 (KR) 10-2009-0119550

(51) Int. Cl. G06F 15/16

(52) U.S. Cl. 709/206

(57) ABSTRACT

Disclosed is an interactive test apparatus and method to block an IP application spam. The interactive test apparatus may include a test determining unit to determine whether to perform an interactive test to block an IP application spam, a test level determining unit to determine a level of the interactive test to be performed to a service transmitting unit with respect to an IP application for which the interactive test determining unit determines to perform the interactive test, and testing unit to perform the interactive test at the level corresponding to the IP application based on the level determined by the test level determining unit.

### CROSS-REFERENCE TO RELATED APPLICATION

This application claims the benefit of Korean Patent Application No. 10-2009-0119550, filed on Dec. 4, 2009, in the Korean Intellectual Property Office, the disclosure of which is incorporated herein by reference.

### BACKGROUND

1. Field of the Invention

The present invention relates to an interactive test apparatus and method for cutting an Internet protocol (IP) application spam, and more particularly, to an interactive test apparatus and method that may perform an interactive test on an IP application at a determined level.

2. Description of the Related Art

Generally, a spam e-mail that is an undesired massively distributed commercial e-mail has caused various damages to users. Recently, as Internet protocol (IP) application services, such as an Internet phone, an instant message, and the like, are being developed, a spam based on the IP application service is emerging and is detrimental.

An IP application service may have difficulty in identifying the spam, compared with an e-mail service, since an IP application service provides a multimedia service and a real-time service. A part of a conventional method of blocking the spam may be applicable to the IP application spam. However, a modified method of blocking the spam may be desirable for effectively blocking the spam.

### SUMMARY

An aspect of the present invention provides an interactive test apparatus and method that may perform an interactive test with respect to a service transmitter to detect and block a spam generated in an Internet protocol (IP) application.

Another aspect of the present invention also provides an interactive test apparatus and method that may perform an interactive test with respect to each IP application at a different level based on a policy to block an IP application spam and the like, and thus may block a spam based on different characteristics of the IP application and different spam blocking policies.

According to an aspect of the present invention, there is provided an interactive test apparatus, the apparatus including a test determining unit to determine whether to perform an interactive test to block an IP application spam, a test level determining unit to determine a level of the interactive test to be performed to a service transmitting unit with respect to an IP application for which the interactive test determining unit determines to perform the interactive test, and a testing unit to perform the interactive test at the level corresponding to the IP application based on the level determined by the test level determining unit.

The apparatus may further include an interactive test information unit to provide various information used when the test determining unit, the test level determining unit, and the testing unit perform the interactive test.

The interactive test information unit may include a test determination information unit to provide, to the test determining unit, test determination information requested by the test determining unit to determine whether to perform the interactive test.

The interactive test information unit may include a test level determination information unit to provide, to the test level determining unit, test level determination information requested by the test level determining unit to determine the level of the interactive test.

The interactive test information unit may include a test information unit to provide, to the testing unit, test information requested by the testing unit to determine whether a target of the test is a spam based on a result of the interactive test.

The test determination information unit may receive, from a service receiving unit, test determination policy information associated with the determining of whether to perform the interactive test.

The test level determination information unit may receive, from a service receiving unit, test level determination policy information associated with the determining of the level of the interactive test.

The test information unit may receive, from the service receiver, test policy information associated with the determining of the spam based on the interactive test and the result of the interactive test.

According to an aspect of the present invention, there is provided an interactive test method, and the method includes determining, by a test determining unit, whether to perform an interactive test to block an IP application spam, determining, by a test level determining unit, a level of the interactive test to be performed to a service transmitting unit with respect to an IP application for which the interactive test to be performed, and performing, by a testing unit, the interactive test on the IP application based on the determined level of the interactive.

The method may further include providing, by an interactive test information unit, information used when the test determining unit, the test level determining unit, and a testing unit perform the interactive test.

The interactive test information unit may include a test determination information unit; and the determining of whether to perform the interactive test may include requesting, by the test determining unit, information used for determining whether to perform the interactive test from the test determination information unit, receiving, by the test determining unit, the requested information from the test determination information unit, and determining, by the test determining unit, whether to perform the interactive test based on the received information.

The interactive test information unit may include a test level determination information unit, and the determining of the level of the interactive test to be performed may include requesting, by the test level determining unit, test level information used for determining the level of the interactive test, receiving, by the test level determining unit, the requested test level information from the test level determination information unit, and determining, by the test level determining unit, determining the level of the interactive test to be performed with respect to the IP application based on the received test level information.

The interactive test information unit may include a test information unit, and the performing of the interactive test may include requesting, by the testing unit, test information used for determining whether a target of the test is a spam based on a result of the interactive test from the test information unit, receiving, by the testing unit, the requested test information from the test information unit, and determining, by the testing unit, whether the IP application is the spam at the determined level of the interactive test based on the received test information.

The method may further include providing, by a service receiving unit, test determination policy information associated with the determining of whether to perform the interactive test to the test determination information unit.

The method may further include providing, by a service receiving unit, test level determination policy information associated with the determining of the level of the interactive test to the test level determination information unit.

The method may further include providing, by a service receiving unit, test policy information associated with the determining of the spam to the test information unit.

Additional aspects, features, and/or advantages of the invention will be set forth in part in the description which follows and, in part, will be apparent from the description, or may be learned by practice of the invention.

### EFFECT

According to the present invention, there may be provided an interactive test apparatus and method performing an interactive test with respect to a service transmitter to detect and block a spam being generated in an IP application.

According to the present invention, there may be provided an interactive test apparatus and method performing an interactive test with respect to each IP application at a different level based on an IP application spam blocking policy and the like, and thus may block a spam based on different characteristics of the IP application and different spam blocking policies.

### BRIEF DESCRIPTION OF THE DRAWINGS

These and/or other aspects, features, and advantages of the invention will become apparent and more readily appreciated from the following description of embodiments, taken in conjunction with the accompanying drawings of which:

FIG. 1 is a diagram illustrating a configuration of an interactive test apparatus according to an embodiment of the present invention;

FIG. 2 is a flowchart illustrating an interactive test method according to an embodiment of the present invention;

FIG. 3 is a diagram illustrating an example of a process to determine whether to perform an interactive test;

FIG. 4 is a diagram illustrating an example of a process to determine a level of an interactive test; and

FIG. 5 is a diagram illustrating an example of a process to perform an interactive test for blocking an Internet protocol (IP) application spam.

### DETAILED DESCRIPTION

Reference will now be made in detail to embodiments of the present invention, examples of which are illustrated in the accompanying drawings, wherein like reference numerals refer to the like elements throughout. Embodiments are described below to explain the present invention by referring to the figures.

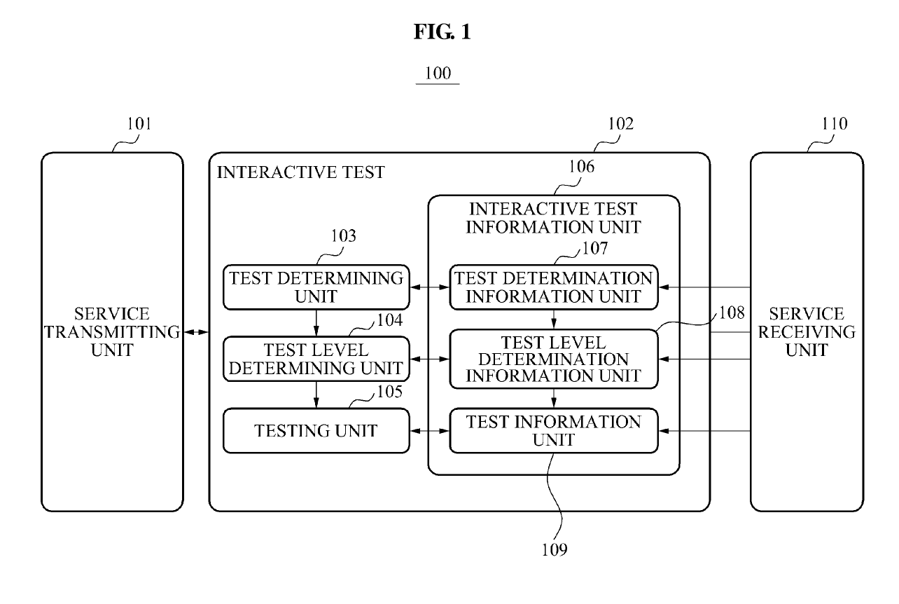

FIG. 1 illustrates a configuration of an interactive test apparatus 100 according to an embodiment of the present invention. Referring to FIG. 1, the interactive test apparatus 100 may include a service transmitting unit 101, an interactive testing unit 102, and a service receiving unit 110.

The service transmitting unit 101 may generate an Internet protocol (IP) application and may transmit the generated IP application to the service receiving unit 110. For example, the service transmitting unit 101 may be a person or an entity which transmits the generated IP application.

The interactive testing unit 102 may perform an interactive test to block the IP application spam, and may include a test determining unit 103, a test level determining unit 104, a testing unit 105, and an interactive test information unit 106. The interactive test tests whether a target of the interactive test appropriately interacts in the manner as the interactive testing unit 102 desires. The interactive testing unit 102 may determine whether to perform the interactive test with respect to the IP application transmitted from the transmitting unit 101, may determine a level of the interactive test to be performed, may perform the interactive test, and may store information associated with the interactive test. The interactive testing unit 102 may perform the interactive test on each IP application at different level based on a spam blocking policy of the service receiving unit 110 or a spam blocking policy of the interactive testing unit 102. Accordingly, spam blocking may block a spam based on different characteristics of the IP application and different spam blocking policies.

When the IP application is received from the service transmitting unit 101, the interactive testing unit 102 may determine a receiver and a transmitter of the IP application, and may determine a blacklist and a white list of the receiver. In this case, when the transmitter is on the blacklist, the interactive testing unit 102 may determine the IP application as a spam, and when the transmitter is on the white list, the interactive testing unit 102 may determine that the IP application is different from the spam

The test determining unit 103 may determine whether to perform the interactive test to block the IP application spam. Specifically, the test determining unit 103 may determine whether to perform the interactive test with respect to the IP application received from the service transmitting unit 101. For example, when an identifier of the transmitter does not exist in both the blacklist and the white list, the test determining unit 103 may determine to perform the interactive test to determine whether the IP application is a spam.

The test level determining unit 104 may determine a level of the interactive test to be performed to the service transmitting unit 101 with respect to the IP application for which the interactive test determining unit 103 determines to perform the interactive test. In this case, a degree of effort, knowledge, and intelligence that may be requested, by the interactive testing unit 102, from the service transmitting unit 101 for passing the interactive test may be different based on the determined level of the interactive test. For example, the interactive testing unit 102 may make a request such as “press #1 on your terminal” from the service transmitting unit 101 when the level of the interactive test is a level 1. As another example, the interactive testing unit 102 may make a request such as “enter age of receiver” from the service transmitting unit 101 when the level of the interactive test is a level 2. In this case, a case where the level of the interactive test is the level 12 uses a greater amount of knowledge about the service receiving unit 110 than a case where the level of the interactive test is the level 21. When the test level determining unit 104 desires information to determine the level of the interactive test to be performed to the IP application, the interactive testing unit 102 may request and receive the information from the interactive test information unit 106.

The testing unit 105 may perform the interactive test at the level corresponding to the IP application based on the level determined by the test level determining unit 104. The testing unit 105 may perform the interactive test with respect to the service transmitting unit 110 or with respect to a network element between the service transmission unit 101 and the interactive testing unit 102, and may determine whether the IP application is a spam based on a result of the interactive test.

The interactive test information unit 106 may include a test determination information unit 107, a test level determination information unit 108, and a test information unit 109 to provide various information used for the interactive test performed by the test determining unit 103, the test level determining unit 104, and the testing unit 105.

The test determination information unit 107 may provide, to the test determining unit, test determination information requested by the test determining unit to determine whether to perform the interactive test. The test determination information unit 107 may receive, from the service receiving unit 110, test determination policy information of service receiving unit 110, which is associated with the determining whether to perform the interactive test.

The test determining unit 103 may request, from the test determination information unit 107, test determination information used for determining whether to perform the interactive test, may receive the requested test determination information from the test determination information unit 107, and may determine whether to perform the interactive test based on the provided test determination information. The test determination information may include the test determination policy information of the service receiving unit 110, which is associated with the determining whether to perform the interactive test.

The test level determination information unit 108 may provide, to the test level determining unit 104, test level determination information requested by the test level determining unit 104 to determine a level of the interactive test. The test level determination information unit 108 may receive, from the service receiving unit 110, a test level policy information of the service receiving unit 110, which is associated with the determining the level of the interactive test.

The test level determining unit 104 may request, from the test level determination information unit 108, test level determination information used for determining the level of the interactive test, may receive the requested test level determination information from the test level determination information unit 108, may determine the level of the interactive test based on the provided test level determination information. The test level determination information may include the test level policy information of the service receiving unit 110, which is associated with the determining the level of the interactive test.

The test information unit 109 may provide, to the testing unit 105, test information requested by the testing unit 105 to determine whether a target of the test is a spam based on a result of the interactive test. The test information unit 109 may receive, from the service receiving unit 110, test policy information of the service receiving unit 110, which is associated with the determining of the spam based on the interactive test and a result of the interactive test

The test information unit 105 may request, from the test information unit 109, the test information used for determining whether the target of the test is the spam based on the result of the interactive test, may receive the requested test information from the test information unit 109 and may perform the interactive test with respect to the IP application at the determined level of the interactive test based on the provided test information. The test information may include the test policy information of the service receiving unit 110, which is associated with the determining of the spam based on the interactive test and the result of the interactive test.

The service receiving unit 110 may receive the IP application from the service transmitting unit 101. For example the service receiving unit 110 may be a person or an entity that receives the IP application transmitted from the service transmitting unit 101. The service receiving unit 110 may provide, to the interactive test information unit 106, various information associated with a policy to block an IP application spam. For example, the service receiving unit 110 may provide, to test determination information unit 107, information associated with determining whether to perform the interactive test. For another example, the service receiving unit 110 may provide, to the test level determination information unit 108, policy information associated with the determining of the level of the interactive test. For another example, the service receiving unit 110 may provide, to the test information unit 109, policy information associated with determining of the spam based on the interactive test and the result of the interactive test.

The interactive test apparatus 100 may perform an interactive test at a different level with respect to each IP application based on an IP application spam blocking policy transmitted to the service receiving unit 110, and thus may block a spam based on different characteristics of the IP application and different spam blocking policies.

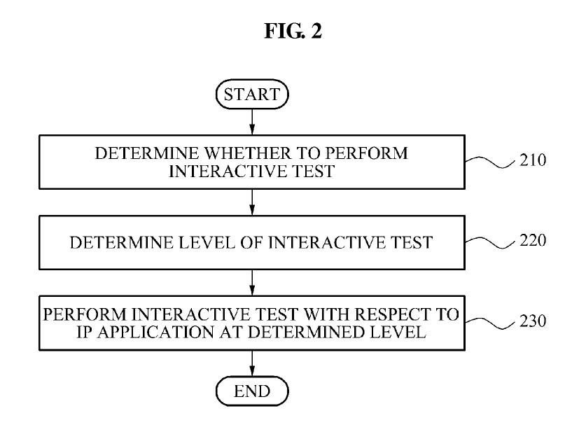

FIG. 2 illustrates an interactive test method according to an embodiment of the present invention.

Referring to FIGS. 1 and 2, the test determining unit 103 determines whether to perform an interactive test to block an IP application spam in operation 210. An operation where the interactive test information unit 106 provides various information used for performing the interactive test to the test determining unit 103 may be further included. For example, the interactive test information unit 106 may provide, to the test determining unit 103, test determination information used for determining whether to perform the interactive test.

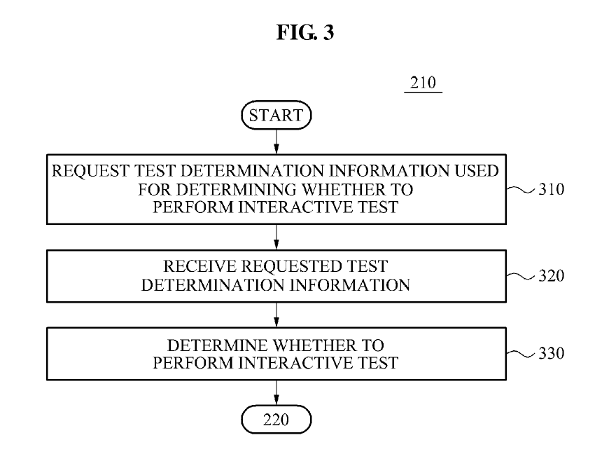

FIG. 3 illustrates an example of a process to determine whether to perform an interactive test.

Referring to FIGS. 1 through 3, the test determining unit 103 may request, from the test determination information unit 107, test determination information used for determining whether to perform an interactive test in operation 310.

The test determining unit 103 receives the requested test determination information from the test determination information unit 107 in operation 320. An operation where the service receiving unit 110 provides policy information associated with the determining of whether to perform the interactive test to the test determination information unit 107 may be further included. The requested test determination information may include policy information associated with the determining whether to perform the interactive test.

The test determining unit 103 determines whether to perform the interactive test based on the provided test determination information in operation 330.

The test level determining unit 104 determines a level of the interactive test with respect to an IP application for which the interactive test is to be performed. An operation where the interactive test information unit 106 provides information used for determining the level of the interactive test to the test level determining unit 140 may be further included. For example, the test level determining unit 104 receives test level determination information used for determining the level of the interactive test from the interactive test information unit 106.

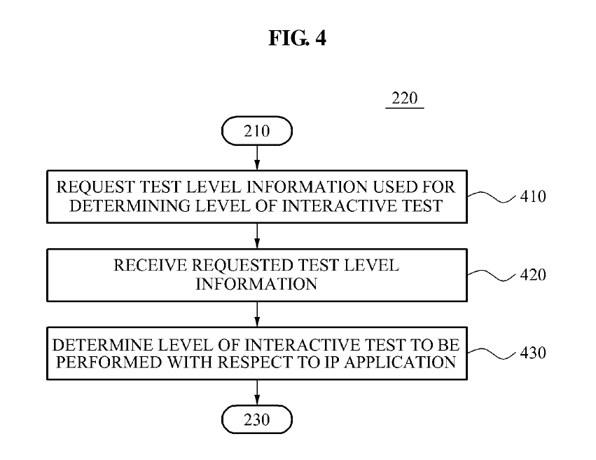

FIG. 4 illustrates an example of a process to determine an interactive test level.

Referring to FIGS. 1 through 4, the test level determining unit 104 requests, from the test level determination information unit 108, test level information to determine a level of an interactive test in operation 410.

The test level determination unit 104 receives, from the test level determination information unit 108, the requested test level information in operation 420. An operation where the service receiving unit 110 provides, to the test level determination information unit 108, test level policy information associated with the determining the level of the interactive test may be further included. For example, the requested test level information may include the test level policy information associated with the determining the level of the interactive test.

In operation 430, the level of the interactive test is determined with respect to the IP application based on the provided test level information.

In operation 230, the testing unit 105 performs the interactive test with respect to the IP application based on the determined level of the interactive test. An operation where the interactive test information unit 106 provides, to the testing unit 105, information used for performing the interactive test may be further included. For example, the testing unit 105 may receive, from the interactive test information unit 106, test information used for performing the interactive test.

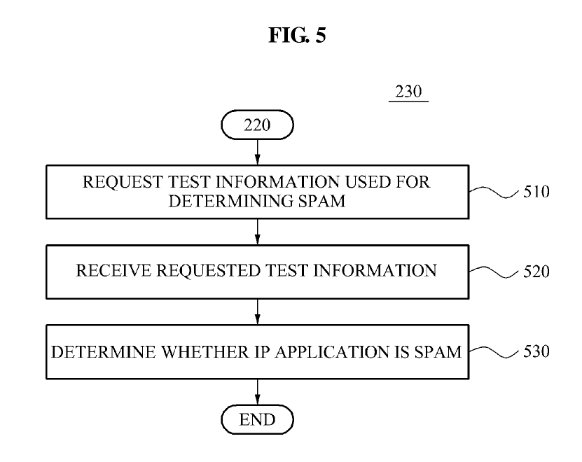

FIG. 5 illustrates an example of a process to perform an interactive test for blocking an IP application spam.

Referring to FIGS. 1 through 5, the testing unit 105 may request, from the test information unit 109, test information used for determining whether a target of the test is a spam based on a result of an interactive test in operation 510.

In operation 520, the testing unit 105 receives the requested test information from the test information unit 109. An operation where the service receiving unit 110 provides, to the test information unit 109, test policy information associated with the determining of the spam based on the interactive test and the result of the interactive test may be further included. The requested test information may include the test policy information associated with the determining of the spam based on the interactive test and the result of the interactive test.

In operation 530, the testing unit 105 determines whether an IP application is a spam based on a level of the interactive test, the level being determined based on the provided test information.

As described above, an interactive test method according to an embodiment of the present invention may perform an interactive test, at a different level, with respect to each IP application based on a policy to block an IP application spam transmitted to the service receiving unit 110 and the like, and thus, may block a spam based on different characteristics of the IP application and different spam blocking policies.

Although a few embodiments of the present invention have been shown and described, the present invention is not limited to the described embodiments. Instead, it would be appreciated by those skilled in the art that changes may be made to these embodiments without departing from the principles and spirit of the invention, the scope of which is defined by the claims and their equivalents.

What is claimed is:

1. An interactive test apparatus, the apparatus comprising:
a test determining unit to determine whether to perform an interactive test to block an IP application spam;
a test level determining unit to determine a level of the interactive test to be performed to a service transmitting unit with respect to an IP application for which the interactive test determining unit determines to perform the interactive test; and
a testing unit to perform the interactive test at the level corresponding to the IP application based on the level determined by the test level determining unit.

2. The apparatus of claim 1, further comprising:
an interactive test information unit to provide various information used when the test determining unit, the test level determining unit, and the testing unit perform the interactive test.

3. The apparatus of claim 2, wherein the interactive test information unit includes a test determination information unit to provide, to the test determining unit, test determination information requested by the test determining unit to determine whether to perform the interactive test.

4. The apparatus of claim 2, wherein the interactive test information unit includes a test level determination information unit to provide, to the test level determining unit, test level determination information requested by the test level determining unit to determine the level of the interactive test.

5. The apparatus of claim 2, wherein the interactive test information unit includes a test information unit to provide, to the testing unit, test information requested by the testing unit to determine whether a target of the test is a spam based on a result of the interactive test.

6. The apparatus of claim 3, wherein the test determination information unit receives, from a service receiving unit, test determination policy information associated with the determining of whether to perform the interactive test.

7. The apparatus of claim 4, wherein the test level determination information unit receives, from a service receiving unit, test level determination policy information associated with the determining of the level of the interactive test.

8. The apparatus of claim 5, wherein the test information unit receives, from the service receiver, test policy information associated with the determining of the spam based on the interactive test and the result of the interactive test.

9. An interactive test method, the method comprising:
determining, by a test determining unit, whether to perform an interactive test to block an IP application spam;
determining, by a test level determining unit, a level of the interactive test to be performed to a service transmitting unit with respect to an IP application for which the interactive test to be performed; and
performing, by a testing unit, the interactive test on the IP application based on the determined level of the interactive.

10. The method of claim 9, further comprising:
providing, by an interactive test information unit, information used when the test determining unit, the test level determining unit, and a testing unit perform the interactive test.

11. The method of claim 10, wherein:
the interactive test information unit includes a test determination information unit; and
the determining of whether to perform the interactive test comprises:
requesting, by the test determining unit, information used for determining whether to perform the interactive test from the test determination information unit;
receiving, by the test determining unit, the requested information from the test determination information unit; and
determining, by the test determining unit, whether to perform the interactive test based on the received information.

12. The method of claim 10, wherein:
the interactive test information unit includes a test level determination information unit; and
the determining of the level of the interactive test to be performed comprises:
requesting, by the test level determining unit, test level information used for determining the level of the interactive test;
receiving, by the test level determining unit, the requested test level information from the test level determination information unit; and
determining, by the test level determining unit, determining the level of the interactive test to be performed with respect to the IP application based on the received test level information.

13. The method of claim 10, wherein:
the interactive test information unit includes a test information unit; and
the performing of the interactive test comprises:
requesting, by the testing unit, test information used for determining whether a target of the test is a spam based on a result of the interactive test from the test information unit;
receiving, by the testing unit, the requested test information from the test information unit; and
determining, by the testing unit, whether the IP application is the spam at the determined level of the interactive test based on the received test information.

14. The method of claim 11, further comprising:
providing, by a service receiving unit, test determination policy information associated with the determining of whether to perform the interactive test to the test determination information unit.

15. The method of claim 12, further comprising:
providing, by a service receiving unit, test level determination policy information associated with the determining of the level of the interactive test to the test level determination information unit.

16. The method of claim 13, further comprising:
providing, by a service receiving unit, test policy information associated with the determining of the spam to the test information unit.
